(19) United States
(12) Patent Application Publication
(10) Pub. No.: US 2026/0274262 A1
(43) Pub. Date: Sep. 17, 2026

(54) INCHING CONTROL SYSTEM

(71) Applicant: Crown Equipment Corporation, New Bremen, OH (US)

(72) Inventors: Joseph Wilker, Saint Marys, OH (US); Praveen Bennur, Troy, OH (US); Logan Pfeifer, Saint Marys, OH (US); Brayden Cates, Anna, OH (US)

(21) Appl. No.: 19/529,293

(22) Filed: Feb. 4, 2026

Related U.S. Application Data
(60) Provisional application No. 63/762,338, filed on Feb. 24, 2025.

(51) Int. Cl. B60W 30/18; B60W 10/08; B60W 10/184

(52) U.S. Cl. CPC B60W 30/18063; B60W 10/08; B60W 10/184; B60W 2300/121; B60W 2540/12; B60W 2710/08; B60W 2710/18; B60W 2720/10

(57) ABSTRACT

A method is provided comprising: receiving, by a vehicle control module on a materials handling vehicle a brake control device input to control vehicle braking. The vehicle control module determines a maximum pre-setpoint vehicle speed to be a first value equal to a maximum speed of the vehicle when the brake control device input is zero, determines the maximum pre-setpoint vehicle speed to be a second value less than the first value when the brake control device input is at a value greater than zero and less than a predefined brake control device input value, and determines the maximum pre-setpoint vehicle speed to be a third value equal to zero when the brake control device input is equal to or greater than the predefined brake control input value.

### CROSS REFERENCE TO RELATED APPLICATIONS

This application claims the benefit of U.S. Provisional Patent Application Ser. No. 63/762,338, filed Feb. 24, 2025, entitled “INCHING CONTROL SYSTEM”, the disclosure of which is hereby incorporated by reference.

### BACKGROUND

U.S. Pat. No. 8,775,039 discloses a dual-purpose inch/brake pedal in an engine-based vehicle. The inch/brake pedal operates to engage a vehicle braking system, and also to engage a vehicle transmission. Typically, the braking system is fully engaged when the inch/brake pedal is fully depressed, whereas the vehicle transmission is fully engaged when the inch/brake pedal is fully released. Inching occurs in an intermediate range of motion of the inch/brake pedal when the vehicle transmission is only partially engaged.

### BRIEF SUMMARY

In accordance with a first aspect, a method is provided comprising: receiving, by a vehicle control module on a materials handling vehicle a brake control device input to control vehicle braking. The vehicle control module determines a maximum pre-setpoint vehicle speed to be a first value equal to a maximum speed of the vehicle when the brake control device input is zero, determines the maximum pre-setpoint vehicle speed to be a second value less than the first value when the brake control device input is at a value greater than zero and less than a predefined brake control device input value, and determines the maximum pre-setpoint vehicle speed to be a third value equal to zero when the brake control device input is equal to or greater than the predefined brake control input value.

A speed setpoint may be determined based on the maximum pre-setpoint vehicle speed value and a traction motor on the vehicle is controlled based on the speed setpoint.

The maximum pre-setpoint vehicle speed value may be received by a traction control module which determines a speed setpoint based on the maximum pre-setpoint vehicle speed value, a traction control device input value and a shaping curve, wherein the traction control module controls a traction motor on the vehicle based on the speed setpoint.

The brake control device input may have a range from 0% to 100%. The predefined brake control device input value may fall within a range from 40% to 80% or within a range from 50% to 70%.

When the brake control device input is greater than the predefined brake control device input value, braking may occur.

When a traction control input is zero and the brake control device input is greater than zero and less than the predefined brake control device input value, braking may occur.

When a traction control input is zero and the brake control device input is greater than zero, braking may occur.

In accordance with a second aspect, a materials handling vehicle control system is provided comprising: a memory storing executable instructions; a processor in communication with the memory; and a brake control device input sensor configured to generate a brake control device input to be received by the processor to control vehicle braking. Execution of the executable instructions by the processor may cause the processor to: determine a maximum pre-setpoint vehicle speed to be a first value equal to a maximum speed of the vehicle when the brake control device input is zero, determine the maximum pre-setpoint speed to be a second value less than the first value when the brake control device input is at a value greater than zero and less than a predefined brake control device input value, and determine the maximum pre-setpoint speed to be a third value equal to zero when the brake control device input is equal to or greater than the predefined brake control input value.

A traction control module may be further provided, wherein the maximum pre-setpoint vehicle speed is received by the traction control module which determines a speed setpoint based on the maximum pre-setpoint vehicle speed value, a traction control device input value and a shaping curve.

The brake control device input has a range from 0% to 100%. The predefined brake control device input value may fall within a range from 40% to 80% or fall within a range from 50% to 70%.

When the brake control device input is greater than the predefined brake control device input value, a speed setpoint in the direction of travel of the materials handling vehicle is set to zero and braking may occur.

When a traction control input to the processor is zero and the brake control device input value is greater than zero and less than the predefined brake control device input value, braking may occur.

When a traction control input to the processor is zero and the brake control device input value is greater than zero, braking may occur.

### BRIEF DESCRIPTION OF THE SEVERAL VIEWS OF THE DRAWINGS

FIG. 1 is a perspective view of a materials handling vehicle illustrated as a sit-down counterbalanced lift truck operable in accordance with teachings of the present application;

FIG. 2 is a side plan view of the counterbalanced lift truck of FIG. 1;

FIG. 3 is schematic view of several components of the materials handling vehicle of FIGS. 1 and 2;

FIGS. 4 and 5 are example plots from which maximum pre-setpoint vehicle speed values, speed setpoint percentages or factors and speed setpoint values may be calculated; and

FIG. 6 depicts a flowchart of an example control algorithm or method of implementing an aspect of the disclosure.

### DETAILED DESCRIPTION

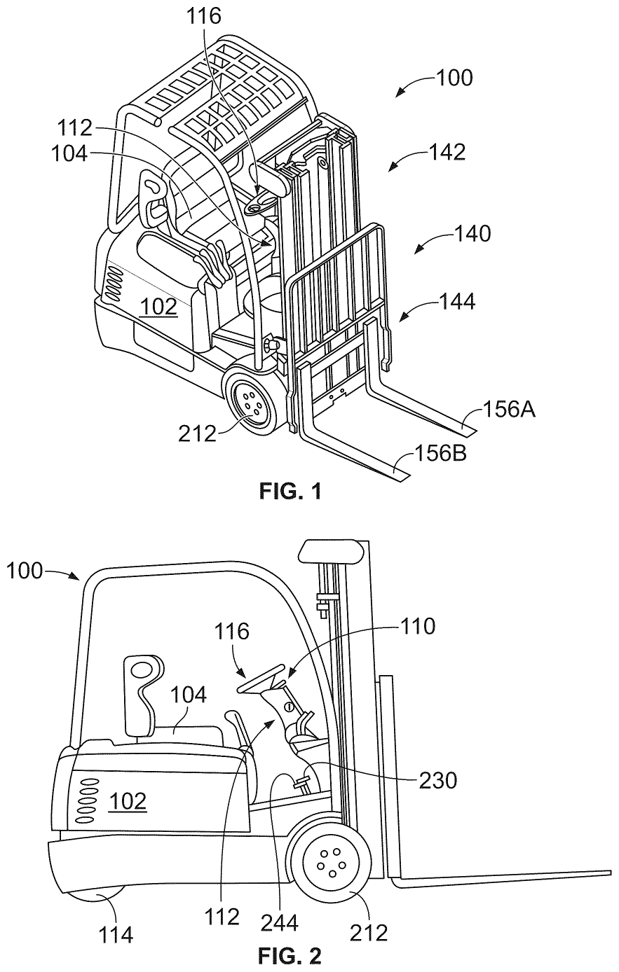

Reference is made to FIGS. 1 and 2, which are perspective and side plan views, respectively, of a materials handling vehicle comprising a three-wheel sit-down counterbalanced lift truck 100. While the method and system for controlling materials handling vehicles set out herein may be used in the sit-down counterbalanced lift truck 100, it will be apparent to those skilled in the art that the subject matter set out herein and variations thereof may be incorporated into a variety of other materials handling vehicles (also referred to herein as “industrial vehicles”).

The vehicle 100 includes a main body or power unit 102, which includes a frame defining a main structural component of the vehicle 102 and which houses a battery (not shown) for powering various components of the vehicle 102. The vehicle 102 further comprises first and second driven wheels 212 mounted to a front side of the power unit 102 and a steered wheel 114 mounted to a rear of and generally under the power unit 102, see FIG. 2.

An operator's compartment is located within the power unit 102 for receiving an operator driving the vehicle 10. A steering wheel 116 is provided on a steering column 112 within the operator's compartment for controlling steering of the vehicle 100. The direction of movement (forward or reverse) of the vehicle 100 may be controlled by the operator via a forward reverse lever 110. The speed of the vehicle 100 may be controlled by the operator using a traction control input device such as a foot actuated accelerator pedal 244, see FIG. 2. Vehicle braking may be controlled by the operator using a brake control device, such as a foot actuated braking pedal 230, see FIG. 2. The vehicle 100 may further include an overhead guard including a vertical support structure affixed to the vehicle frame.

A load handling assembly 140 of the vehicle 100, coupled to the power unit 102, may include, generally, a mast assembly 142 and a carriage assembly 144, which is movable vertically along the mast assembly 142. The mast assembly 142 may include a fixed mast member affixed to the frame, and nested first and second movable mast members. It is noted that the mast assembly 142 may include additional or fewer movable mast members than the two shown in FIG. 1, i.e., the first and second movable mast members. The carriage assembly 144 may include conventional structure including a fork carriage and fork structure comprising a pair of forks 156A, 156B.

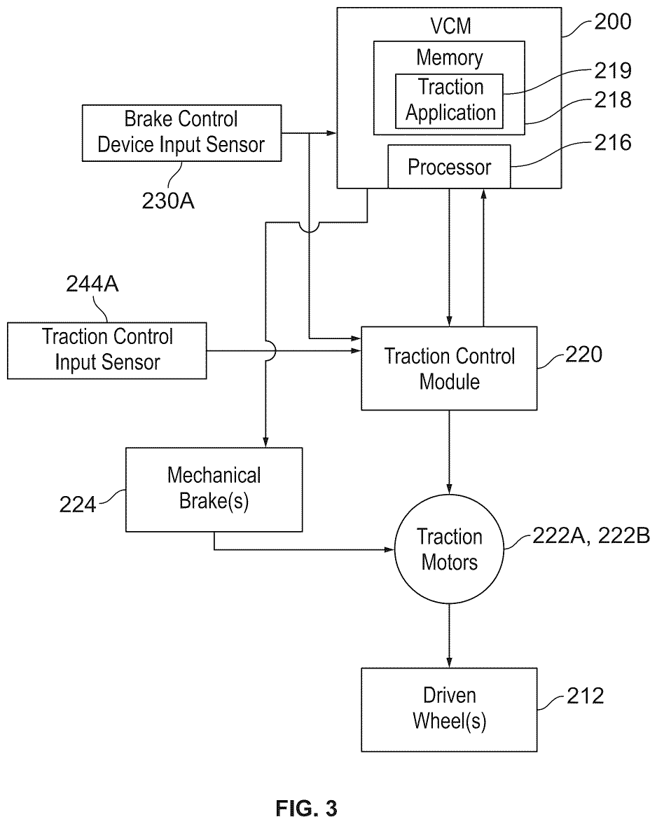

FIG. 3 depicts a block-level view of a computing environment for providing control logic and software applications in a vehicle control module (VCM) 200, according to one or more embodiments shown and described herein. In the illustrated embodiment, the VCM 200 may include one or more electronic processors or microcontrollers 216, input/output hardware, network interface hardware, a data storage component, and a memory component 218. The data storage component and the memory component 218 may each be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Any stored information that is intended to be available after the vehicle 100 is shutdown and restarted may beneficially be stored in non-volatile memory. Also, depending on the particular embodiment, the non-transitory computer-readable medium, mentioned above, may reside within the VCM 200 and/or external to the VCM 200.

Additionally, the memory component 218 may store software or applications that can be executed (i.e., using executable code) by the one or more processors or microcontrollers 216. Thus the memory component 218 may store an operating application or logic, a traction application or logic 219, and a steering application or logic. The operating logic may include an operating system and other software such as, for example, diagnostic-related applications for managing components of the VCM 200. The traction application or logic 219 may be configured with one or more algorithms and parameters for facilitating optimal traction control for the vehicle 100. The steering application or logic may be configured with one or more algorithms and parameters for facilitating optimal steering control of the vehicle 100. A local communication interface may also be included and may be implemented as a bus or other communication interface to facilitate communication among the components of the VCM 200.

The one or more processors or microcontrollers 216 may include any processing component operable to receive and execute instructions (such as from the data storage component and/or the memory component 218). The one or more processors or microcontrollers 216 may comprise any kind of a device which receives input data, processes that data through computer instructions, and generates output data. Such a processor can be a microcontroller, a hand-held device, laptop or notebook computer, desktop computer, microcomputer, digital signal processor (DSP), mainframe, server, cell phone, personal digital assistant, other programmable computer devices, or any combination thereof. Such processors can also be implemented using programmable logic devices such as field programmable gate arrays (FPGAs) or, alternatively, realized as application specific integrated circuits (ASICs) or similar devices. The term “processor” is also intended to encompass a combination of two or more of the above recited devices, e.g., two or more microcontrollers.

It should be understood that the components illustrated in FIG. 3 are merely exemplary and are not intended to limit the scope of this disclosure. While the operating application or logic, the traction application or logic 219, and the steering application or logic are discussed herein as residing on the VCM 200, this is merely an example, as one or more of the operating application or logic, the traction application or logic 219, and the steering application or logic may reside on different devices. Additionally, while the VCM 200 is discussed herein with the traction application 219, the steering application, and the accessory application as separate logical components, this is also an example. In some embodiments, a single, composite software application may cause the VCM 200 to provide the described functionality.

The vehicle may comprise one of a number of cooperating modules, such as the VCM 200, a traction control module (TCM) 220 and/or a steering control module (SCM), that cooperatively control operation of the vehicle 100. The VCM 200, TCM 220 and the SCM may communicate with one another via a controller area network (CAN) interface. It is also contemplated that the VCM 200, TCM 220 and/or the SCM may be provided as a single module operating on a single electronic device. In the embodiment of FIG. 3, the TCM is separate from the VCM 200. The TCM 220 may comprise one or more electronic processors or microcontrollers and a memory component.

As noted above, the VCM 200 may include the microcontroller 216 that includes the traction application 219. As also noted above, the speed of the vehicle 100 may be controlled by the operator actuated accelerator pedal 244. Downward movement of the accelerator pedal 244 may cause actuation of a traction control input sensor 244A, such as a potentiometer or an encoder, which may be coupled to or otherwise associated with the accelerator pedal 244 and may generate a traction control input signal that corresponds or can be processed to correspond to the position of the accelerator pedal 244. Traction control input signals generated by the traction control input sensor 244A may be provided to an input pin of the TCM 220, which then forwards the traction control input signals to the microcontroller 216 of the VCM 200 with no substantive modification. It is also contemplated that the input sensor 244A may provide the traction control input signals directly to the VCM 200.

As noted above, vehicle braking may be controlled by the operator using the foot actuated braking pedal 230. Downward movement of the braking pedal 230 may cause actuation of a brake control device input sensor 230A, such as a potentiometer or an encoder, which may be coupled to or otherwise associated with the brake pedal 230 and may generate a brake control device input signal that corresponds or can be processed to correspond to the position of the brake pedal 230. Brake control device input signals generated by the brake control device input sensor 230A may be provided to an input pin of the microcontroller 216 of the VCM 200 and an input pin of the TCM 220.

The VCM 200 (the traction application) monitors the traction control input signals received from the TCM 220 and the brake control device input signals received from the brake control device input sensor 230A. Traction control input signals may be converted by the VCM 200 and the TCM 220 to a value between 0% or 0 units, which correspond to a 0 or a minimum accelerator pedal position, and 100% or 100 units, which corresponds to a maximum accelerator pedal position. Brake control device input signals may be converted by the VCM 200 and TCM 220 to a value between 0% or 0 units, which corresponds to 0 or minimum brake pedal position and 100% or 100 units, which corresponds to a maximum brake pedal position.

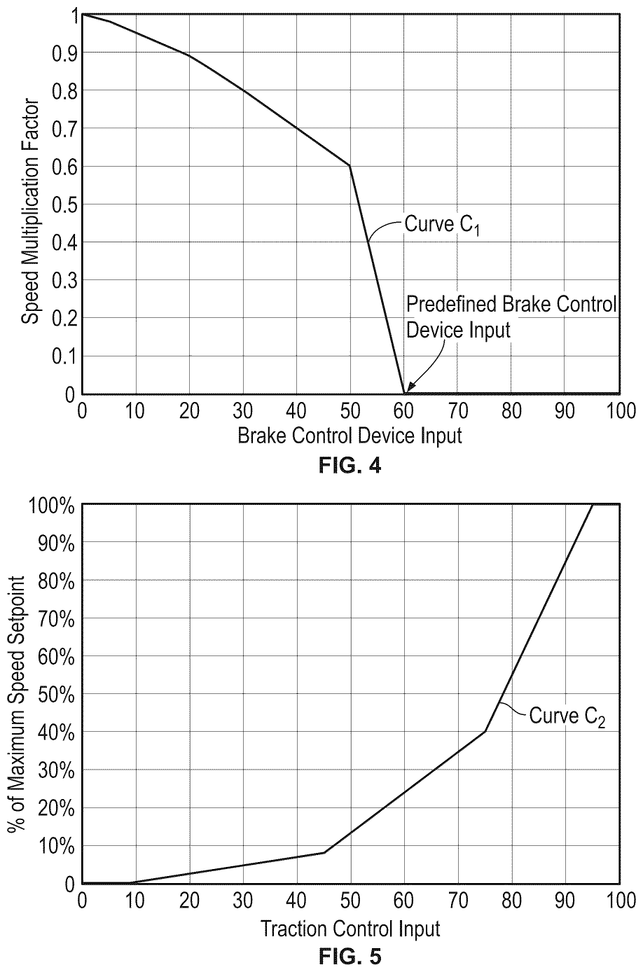

The traction application 219 on the VCM 200 receives the brake control device input signal and calculates a maximum pre-setpoint vehicle speed value, which it forwards to the TCM 220. FIG. 4 provides an example curve Ci illustrating how the VCM 200 may calculate a maximum pre-setpoint vehicle speed value based on a brake control device input signal. Along the x-axis are brake control input values ranging between 0% or 0 units, which corresponds to 0 or a minimum brake pedal position and 100% or 100 units, which corresponds to maximum brake pedal position. Along the y-axis are speed multiplication factors ranging from 0 to 1. As can be seen from Curve C₁, if the brake control device input value is equal to or greater than a predefined brake control device input value, which is 60 units in the FIG. 4 example, the speed multiplication factor is equal to 0. If the brake control device input value is equal to 0, then the multiplication factor is equal to 1. If the brake control device input value is greater than zero and less than the predefined brake control device input value, e.g., 60 units, then the multiplication factor is a value greater than zero and less than 1.

The predefined brake control device input value is a single value that may fall within a range from 40% to 80%, or between a range of 50% to 70%, or between a range of 55% to 65% or may equal 60%. As noted above, in the embodiment of FIG. 4, the predefined brake control device input value is 60%.

The VCM 200 may multiply the speed multiplication factor by the maximum vehicle speed for the vehicle to arrive at a maximum pre-setpoint vehicle speed value, which is forwarded to the TCM 220. The maximum speed may vary if more than one speed mode option is provided and is defined by the speed mode option selected. If, for example, the brake control device input is 50 units, from FIG. 4, the multiplication factor is 0.6. For a maximum vehicle speed of 12 miles/hour (MPH), the maximum pre-setpoint vehicle speed value is . 6×12=7.2 MPH. The maximum pre-setpoint vehicle speed value=7.2 MPH is sent by the VCM 200 to the TCM 220.

The VCM 200 may contain one or more equations in the memory component 218 defined in accordance with Curve C₁ in FIG. 4 or a similar curve to allow the VCM 200 to use an input such as a brake control device input value to calculate a multiplication factor to be used to calculate a maximum pre-setpoint vehicle speed value. Alternatively, the VCM 200 may include a lookup table stored in the memory component 218 which stores points/data from a curve similar to or the same as curve C₁ from FIG. 4 such that a brake control device input value received from the brake control device input sensor 230A may be used by the VCM 200 as an input into the lookup table and an output received from the lookup table comprises a corresponding multiplication factor.

As noted above, the brake control device input sensor 230A is coupled to the TCM 220 such that the TCM receives the brake control device input signal. When the brake control device input value is equal to or greater than the predefined brake control device input value, 60 units in the FIG. 4 example, the TCM 220 effects regenerative braking at a rate of deceleration corresponding to the brake control device input value. Braking occurs when the brake control device input value is equal to or greater than the predefined brake control device input value even if the traction control input signal is greater than 0 units. Regenerative braking may occur at the first and second traction drive motors 222A, 222B coupled respectively to the first and second driven wheels 212. If additional braking capacity is needed, the TCM 220 may instruct the VCM 200 to generate an actuation signal to a mechanical brake 224 coupled to each of the first and second traction drive motors 222A, 222B.

If the brake control device input signal is less than the predefined brake control device input value and greater than 0%, and the traction control input signal is equal to 0%, the TCM 220 may control the traction control motors 222A, 222B to coast or effect regenerative braking at a rate of deceleration corresponding to the brake control device input signal and if additional braking capacity is needed, the VCM 200 may generate an actuation signal to a mechanical brake 224.

If the brake control device input signal is greater than 0 and less than the predefined brake control device input value and the traction control input signal is greater than 0%, the VCM 200 and TCM 220 work together to implement an “inching function.” Hence, the VCM 200 and TCM 220 automatically implement the inching function when the operator is activating the accelerator pedal 244, i.e., the traction control input signal is greater than 0% and, concurrently, is activating the braking pedal 230, but only if the brake control device input signal is greater than 0% and less than the predefined brake control device input value. When the inching function is being implemented, i.e., when the brake control device input signal is greater than 0 and less than the predefined brake control device input value and the traction control input signal is greater than 0%, no braking occurs. The VCM 200 alone or in combination with the TCM 220 defines an inching control system.

The “inching function,” provided by the technology set out herein, allows an operator to control the vehicle's speed with finesse so as to allow the operator to finely adjust the position of the vehicle 100 before committing to a full movement. Hence, an operator can very slowly move the vehicle 100 to engage the forks 156A, 156B with a pallet/load and/or very slowly move the vehicle 100 to position a load to be dropped by the vehicle. In an engine-based materials handling vehicle, an inching pedal may disconnect a transmission from a driven wheel and also function as a brake. The subject matter of this disclosure makes it seamless for an operator to move from an engine-based vehicle to an electric-based vehicle to operate the latter.

When implementing the inching function, the VCM 200 will calculate a maximum pre-setpoint vehicle speed, which is equal to: a maximum vehicle speed (for a currently activated speed mode if more than one speed mode is provided) when the brake control device input value is 0; 0 speed when the brake control device input value is equal to or greater than the predefined brake control input value; and a value greater than 0 speed and less than the maximum vehicle speed when the brake control device input value is greater than 0 unit and less than the predefined brake control device input value.

As noted above, the VCM 200 forwards the maximum pre-setpoint vehicle speed value to the TCM 220. When the inching function is implemented, the TCM 220 multiplies the maximum pre-setpoint vehicle speed value by a speed setpoint percentage or factor, determined by the TCM as discussed below, to calculate a speed setpoint or speed setpoint value, which is used by the TCM 220 to control the speed of the traction motors 222A and 222B coupled to driven wheels 212.

FIG. 5 provides an example Curve C₂ illustrating how the TCM 220 may calculate a speed setpoint percentage or factor based on a traction control input. Along the x-axis are traction control input values ranging between 0% or 0 units, which corresponds to 0 or a minimum accelerator pedal position and 100% or 100 units, which corresponds to a maximum accelerator pedal position. Along the y-axis are speed setpoint percentages or factors ranging from 0%, 0.0 to 100%, 1.0. Curve C₂ is a shaping curve that provides enhanced speed control at low traction control input values. For example, curve C₂ provides speed setpoint percentages or factors at various traction control input values. A speed setpoint percentage or factor is determined from Curve C₂ and used to calculate a corresponding speed setpoint by multiplying the speed setpoint percentage or factor by the maximum pre-setpoint vehicle speed value received from the VCM 200. For example, if the traction control input value=70 units, from Curve C₂, the speed setpoint factor is 0.35. If the maximum pre-setpoint vehicle speed received from the VCM 200=7.2 MPH, then the speed setpoint is 0.35×7.2=2.52 MPH, which is used by the TCM 220 to control the speed of the traction motors 222A and 222B.

The TCM 220 may contain one or more equations in a corresponding memory component defined in accordance with Curve C₂ in FIG. 5 or a similar curve to allow the TCM 220 to use an input such as a traction control input value to calculate a speed setpoint percentage or factor used to calculate a speed setpoint. Alternatively, the TCM 220 may include a lookup table stored in the memory component 218 which stores points/data from a curve similar to or the same as curve C₂ from FIG. 5 such that a traction control input value may be used by the TCM 220 as an input into the lookup table and an output received from the lookup table comprises a corresponding speed setpoint percentage or factor.

Examples of calculating maximum pre-setpoint vehicle speed values, speed setpoint percentages or factors and speed setpoints are set out below.

### Example I

When the brake pedal 230 of the vehicle 100 is not being actuated such that brake control device input value is 0%, the VCM 200 generates a speed multiplication factor=1.0 (see curve C₁ in FIG. 4).

Presuming the maximum vehicle speed is set to 12 mph (high speed vehicle mode is selected), when the vehicle 100 is traveling with the traction control input sensor 244A generating a traction control input value of 75% and the brake pedal 230 is not being actuated concurrently with the accelerator pedal 244 such that brake control device input value is 0%, the VCM 200 calculates a maximum pre-setpoint vehicle speed value equal to: 1 (speed multiplication factor from Curve C₁ in FIG. 4)×12 mph=12 mph. The inching function is not implemented.

Presuming the maximum vehicle speed is set to 8 mph (low speed vehicle mode), when the vehicle 100 is traveling with the traction control input sensor 244A generating a traction control input value of 75% and the brake pedal 230 is not being actuated concurrently with the accelerator pedal 244 such that brake control device input value is 0%, the VCM 200 calculates a maximum pre-setpoint vehicle speed value equal to: 1 (speed multiplication factor from Curve C₁ in FIG. 4)×8 mph=8 mph. The inching function is not implemented.

### Example II

When the brake pedal 230 is actuated and the brake control device input sensor 230A generates a brake control input value of 30%, the VCM 200 generates a speed multiplication factor=0.8 (see curve C₁ in FIG. 4).

Presuming the maximum vehicle speed is set to 12 mph (high speed vehicle mode is selected), when the vehicle 100 is traveling with the traction control input sensor 244A generating a traction control input value of 75% and the brake pedal 230 is actuated concurrently with the accelerator pedal 244 and the brake control device input sensor 230A generates a brake control input value of 30%, the VCM 200 calculates a maximum pre-setpoint vehicle speed value equal to: 0.8 (speed multiplication factor from Curve C₁ in FIG. 4)×12 mph=9.6 mph. A speed setpoint is calculated by the TCM 220 as follows: 9.6 MPH (maximum pre-setpoint vehicle speed value)×0.4 (speed setpoint factor from Curve C₂ in FIG. 5)=3.84 MPH. The inching function is implemented in this example.

Presuming the maximum vehicle speed is set to 8 mph (low speed vehicle mode is selected), when the vehicle 100 is traveling with the traction control input sensor 244A generating a traction control input value of 75% and the brake pedal 230 is actuated concurrently with the accelerator pedal 244 and the brake control device input sensor 230A generates a brake control input value of 30%, the VCM 200 calculates a maximum pre-setpoint vehicle speed value equal to: 0.8 (speed multiplication factor from Curve C₁ in FIG. 4)×8 mph=6.4 mph. A speed setpoint is calculated by the TCM 220 as follows: 6.4 MPH (maximum pre-setpoint vehicle speed value)×0.4 (speed setpoint factor from Curve C₂ in FIG. 5)=2.56 MPH. The inching function is implemented in this example.

### Example III

When the brake pedal 230 is actuated and the brake control device input sensor 230A generates a brake control device input value of 50%, the VCM generates a speed multiplication factor=0.6 (see curve C₁ in FIG. 4).

Presuming the maximum vehicle speed is set to 12 mph (high speed vehicle mode is selected), when the vehicle 100 is traveling with the traction control input sensor 244A generating a traction control input value of 75% and the brake pedal 230 is actuated concurrently with the accelerator pedal 244 and the brake control device input sensor 230A generates a brake control input value of 50%, the VCM 200 calculates a maximum pre-setpoint vehicle speed value equal to: 0.6 (speed multiplication factor from Curve C₁ in FIG. 4)×12 mph=7.2 mph. A speed setpoint is calculated by the TCM 220 as follows: 7.2 MPH (maximum pre-setpoint vehicle speed value)×0.4 (speed setpoint factor from Curve C₂ in FIG. 5)=2.88 MPH. The inching function is implemented in this example.

Presuming the maximum vehicle speed is set to 8 mph (low speed vehicle mode is selected), when the vehicle 100 is traveling with the traction control input sensor 244A generating a traction control input value of 75% and the brake pedal 230 is actuated concurrently with the accelerator pedal 244 and the brake control device input sensor 230A generates a brake control input value of 50%, the VCM 200 calculates a maximum pre-setpoint vehicle speed value equal to: 0.6 (speed multiplication factor from Curve C₁ in FIG. 4)×8 mph=4.8 mph. A speed setpoint is calculated by the TCM 220 as follows: 4.8 MPH (maximum pre-setpoint vehicle speed value)×0.4 (speed setpoint factor from Curve C₂ in FIG. 5)=1.92 MPH. The inching function is implemented in this example.

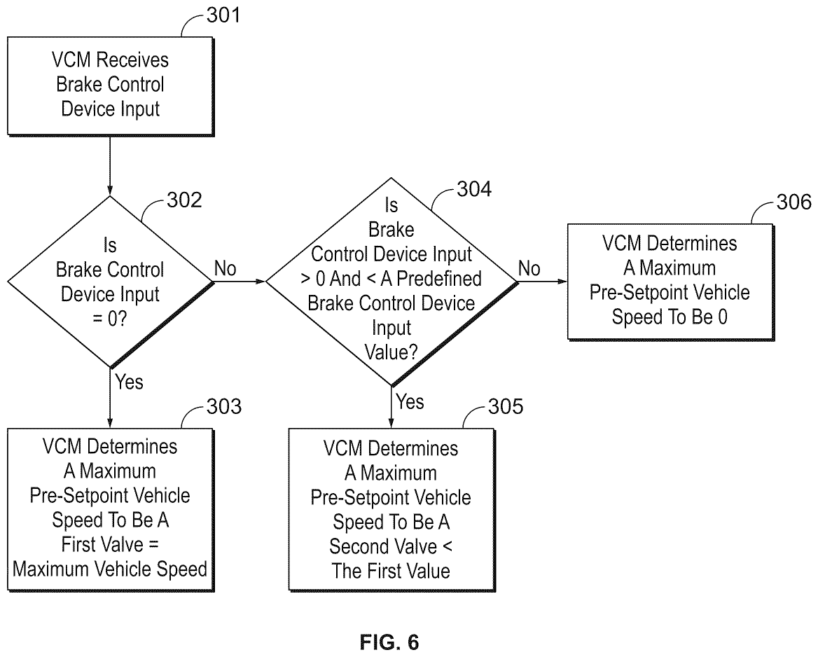

FIG. 6 is a flowchart of an example control algorithm or method for calculating maximum pre-setpoint vehicle speed. In step 301, the VCM 200 receives a brake control device input (also referred to herein as a “brake control device input signal”) from a brake control device input sensor 230A. In step 302, the vehicle control module VCM 200 determines if the brake control device input is zero. If so, in step 303, the VCM 200 determines that a maximum pre-setpoint vehicle speed to be a first value equal to a maximum speed of the vehicle. If the VCM 200 determines that the brake control device input is not equal to 0, in step 304, the VCM 200 determines if the brake control device input is at a value greater than zero and less than a predefined brake control device input value. If so, the VCM 200 determines in step 305 that the maximum pre-setpoint vehicle speed to be a second value less than the first value. If the VCM 200 determines that the brake control device input is not at a value greater than zero and less than a predefined brake control device input value, then the VCM 200 determines in step 306 that the brake control device is equal to or greater than the predefined brake control device input value and defines the maximum pre-setpoint vehicle speed to be zero.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method comprising:
receiving, by a vehicle control module on a materials handling vehicle:
a brake control device input to control vehicle braking;
wherein the vehicle control module determines a maximum pre-setpoint vehicle speed to be a first value equal to a maximum speed of the vehicle when the brake control device input is zero, determines the maximum pre-setpoint vehicle speed to be a second value less than the first value when the brake control device input is at a value greater than zero and less than a predefined brake control device input value, and determines the maximum pre-setpoint vehicle speed to be a third value equal to zero when the brake control device input is equal to or greater than the predefined brake control input value.

2. The method of claim 1, wherein a speed setpoint is determined based on the maximum pre-setpoint vehicle speed value and a traction motor on the vehicle is controlled based on the speed setpoint.

3. The method of claim 1, wherein the maximum pre-setpoint vehicle speed value is received by a traction control module which determines a speed setpoint based on the maximum pre-setpoint vehicle speed value, a traction control device input value and a shaping curve, wherein the traction control module controls a traction motor on the vehicle based on the speed setpoint.

4. The method of claim 1, wherein the brake control device input has a range from 0% to 100%, the predefined brake control device input value falls within a range from 40% to 80%.

5. The method of claim 1, wherein the brake control device input has a range from 0% to 100%, the predefined brake control device input value falls within a range from 50% to 70%.

6. The method of claim 1, wherein when the brake control device input is greater than the predefined brake control device input value, braking occurs.

7. The method of claim 6, wherein when a traction control input is zero and the brake control device input is greater than zero and less than the predefined brake control device input value, braking occurs.

8. The method of claim 1, wherein when a traction control input is zero and the brake control device input is greater than zero, braking occurs.

9. A materials handling vehicle control system comprising:
a memory storing executable instructions;
a processor in communication with the memory;
a brake control device input sensor configured to generate a brake control device input to be received by the processor to control vehicle braking;
execution of the executable instructions by the processor causes the processor to:
determine a maximum pre-setpoint vehicle speed to be a first value equal to a maximum speed of the vehicle when the brake control device input is zero, determine the maximum pre-setpoint speed to be a second value less than the first value when the brake control device input is at a value greater than zero and less than a predefined brake control device input value, and determine the maximum pre-setpoint speed to be a third value equal to zero when the brake control device input is equal to or greater than the predefined brake control input value.

10. The materials handling vehicle control system of claim 9, further comprising a traction control module, wherein the maximum pre-setpoint vehicle speed is received by the traction control module which determines a speed setpoint based on the maximum pre-setpoint vehicle speed value, a traction control device input value and a shaping curve.

11. The materials handling vehicle control system of claim 9, wherein the brake control device input has a range from 0% to 100%, the predefined brake control device input value falls within a range from 40% to 80%.

12. The materials handling vehicle control system of claim 9, wherein the brake control device input has a range from 0% to 100%, the predefined brake control device input value falls within a range from 50% to 70%.

13. The materials handling vehicle control system of claim 9, wherein when the brake control device input is greater than the predefined brake control device input value, a speed setpoint in the direction of travel of the materials handling vehicle is set to zero and braking occurs.

14. The materials handling vehicle of claim 13, wherein when a traction control input to the processor is zero and the brake control device input value is greater than zero and less than the predefined brake control device input value, braking occurs.

15. The materials handling vehicle control system of claim 9, wherein when a traction control input to the processor is zero and the brake control device input value is greater than zero, braking occurs.
